(19) United States
(12) Patent Application Publication
(10) Pub. No.: US 2023/0152112 A1
(43) Pub. Date: May 18, 2023

(54) APPARATUS FOR PROVIDING ESTIMATED TIME OF ARRIVAL ON NAVIGATION ROUTE AND METHOD THEREOF

(71) Applicants: Hyundai Motor Company, Seoul (KR); Kia Corporation, Seoul (KR)

(72) Inventor: Jin Woo Kim, Seoul (KR)

(21) Appl. No.: 17/849,834

(22) Filed: Jun. 27, 2022

(30) Foreign Application Priority Data
Nov. 15, 2021 (KR) 10-2021-0156940

(51) Int. Cl. G01C 21/34; G08G 1/052

(52) U.S. Cl. CPC G01C 21/3492; G08G 1/052

(57) ABSTRACT

Disclosed are an apparatus for providing estimated time of arrival on a navigation route and a method thereof, in which the apparatus includes a controller that collects a vehicle driving speed for each link included in the navigation route, classifies the vehicle driving speed for each link into a plurality of groups, determines a representative speed for each of the plurality of groups, selects a group matching a user past-driving speed for each link, and determines the estimated time of arrival, based on the representative speed of the selected group, and a display that provides a user with the estimated time of arrival.

### CROSS-REFERENCE TO RELATED APPLICATION

This application is based on and claims under 35 U.S.C. § 119(a) the benefit of priority to Korean Patent Application No. 10-2021-0156940, filed in the Korean Intellectual Property Office on Nov. 15, 2021, the entire contents of which are incorporated herein by reference.

### TECHNICAL FIELD

Embodiments of the present disclosure relate to technology for accurately predicting time required for a vehicle to drive a navigation route from a departure point to a destination.

### BACKGROUND

In recent years, most vehicles are each equipped with a navigation system. In addition, traffic congestion frequently occurs on a road, an intersection or the like due to an increased number of vehicles. It is thus common for a user to search for a route by using the navigation in advance even when driving on a road that the user already knows to identify a section such as a road, an intersection or the like, where the traffic congestion occurs in advance, thus avoiding the corresponding section.

In addition, when searching for a route as described above, the user may commonly use estimated time of arrival (ETA). For example, the user may determine departure time or appointment time based on the estimated time of arrival. Therefore, the user may determine the departure time or the appointment time by adding more spare time when the estimated time of arrival is not accurate. On the other hand, the more accurate the estimated time of arrival, the less the spare time necessary to be added, and the user may save time without wasting time on the road.

In conventional technology for providing the estimated time of arrival by a navigation route, a vehicle driving speed (e.g., length of a link divided by time required for a vehicle to pass through the link) may be collected for each link included in the navigation route from a departure point to a destination, and the estimated time of arrival on a navigation route may be determined based on an average value of the collected speeds. Therefore, a large error may occur between an actual arrival time of the vehicle and its estimated time of arrival.

The above information disclosed in this background section is provided only to assist in understanding of the background of the present disclosure and may thus include information not included in the existing technologies already known to those skilled in the art to which embodiments of the present disclosure pertain.

### SUMMARY

An exemplary embodiment of the present disclosure provides an apparatus for providing estimated time of arrival on a navigation route and a method thereof, in which the apparatus may not only minimize an error between an actual arrival time to a destination and the estimated time of arrival, but also provide a customized estimated time of arrival for each user by collecting a vehicle driving speed for each link included in the navigation route, classifying the vehicle driving speed for each link into a plurality of groups (e.g., over-speeding group, average-speeding group and under-speeding group), determining a representative speed for each of the plurality of groups, determining a group matching a user past-driving speed for each link, and determining the estimated time of arrival, based on the determined representative speed for each group.

The technical problems to be solved by embodiments of the present disclosure are not limited to the aforementioned problems, and any other technical problems not mentioned herein will be clearly understood from the following description by those skilled in the art to which embodiments of the present disclosure pertain.

According to an embodiment of the present disclosure, an apparatus for providing estimated time of arrival on a navigation route includes a controller that collects a vehicle driving speed for each link included in the navigation route, classifies the vehicle driving speed for each link into a plurality of groups, determines a representative speed for each of the plurality of groups, selects a group matching a user past-driving speed for each link, and determines the estimated time of arrival, based on the representative speed of the selected group, and a display that provides a user with the estimated time of arrival.

The controller may predict a time period in which the user is expected to drive a vehicle for each link and select a group that includes the user past-driving speed for each link from groups of each link corresponding to the predicted time period.

The controller may calculate vehicle driving time for each link by dividing a length of each link by the representative speed for each link and determine a sum of the vehicle driving time for each link as the estimated time of arrival.

The controller may detect a link having a highest similarity to a link not including a user driving history among links including the user driving history when there is the link not including the user driving history among the links included in the navigation route and determine a group pre-selected in the link having the highest similarity as a group in the link not including the user driving history.

The controller may collect the vehicle driving speed for each link calculated while the vehicle drives each link on the navigation route.

The vehicle may calculate the vehicle driving speed in the link by dividing the length of the link by time required to pass through the link.

The controller may classify the vehicle driving speed for each link into an over-speeding group, an average-speeding group, or an under-speeding group.

The controller may determine an average of all speeds in the group as the representative speed.

The controller may determine an average of specific speeds in the group as the representative speed.

The controller may determine a median value of all speeds in the group as the representative speed.

According to another embodiment of the present disclosure, a method of providing estimated time of arrival on a navigation route includes collecting, by a controller, a vehicle driving speed for each link included in the navigation route, classifying, by the controller, the vehicle driving speed for each link into a plurality of groups, determining, by the controller, a representative speed for each of the plurality of groups, selecting, by the controller, a group matching a user past-driving speed for each link, and determining, by the controller, the estimated time of arrival, based on the representative speed of the selected group, and providing, by a display, a user with the estimated time of arrival.

The selecting of the group matching the user past-driving speed for each link may include predicting a time period in which the user is expected to drive a vehicle for each link and selecting a group that includes the user past-driving speed for each link from groups of each link corresponding to the predicted time period.

The determining of the estimated time of arrival may include calculating vehicle driving time for each link by dividing a length of each link by the representative speed for each link and determining a sum of the vehicle driving time for each link as the estimated time of arrival.

The selecting of the group matching the user past-driving speed may include detecting a link having the highest similarity to a link not including a user driving history among links including the user driving history when there is the link not including the user driving history among the links included in the navigation route and determining a group pre-selected in the link having the highest similarity as a group in the link not including the user driving history.

The collecting of the vehicle driving speed for each link may include calculating the vehicle driving speed for each link while the vehicle drives each link on the navigation route and collecting the calculated vehicle driving speed for each link.

The calculating of the vehicle driving speed for each link may include calculating the vehicle driving speed in the link by dividing the length of the link by time required to pass through the link.

The classifying of the vehicle driving speed for each link into the plurality of groups may include classifying the vehicle driving speed for each link into an over-speeding group, an average-speeding group or an under-speeding group.

The determining of the representative speed for each of the plurality of groups may include determining an average of all speeds in the group as the representative speed.

The determining of the representative speed for each of the plurality of groups may include determining an average of specific speeds in the group as the representative speed.

The determining of the representative speed for each of the plurality of groups may include determining a median value of all speeds in the group as the representative speed.

As discussed, the apparatus and methods suitably include use of a controller or processer.

In another aspect, vehicles are provided that comprise an apparatus and/or method as disclosed herein.

### BRIEF DESCRIPTION OF THE DRAWINGS

The above and other objects, features and advantages of embodiments of the present disclosure will be more apparent from the following detailed description taken in conjunction with the accompanying drawings:

FIG. 1 is an exemplary view of a route guidance system to which an exemplary embodiment of the present disclosure is applied;

FIG. 2 is an exemplary view of a configuration of a vehicle included in the route guidance system to which an exemplary embodiment of the present disclosure is applied;

FIG. 3 is a block diagram of an apparatus for providing estimated time of arrival (ETA) on a navigation route according to an exemplary embodiment of the present disclosure;

FIG. 4 is a flowchart showing a method of providing ETA on a navigation route according to an exemplary embodiment of the present disclosure; and

FIG. 5 is a block diagram showing a computing system for executing the method of providing ETA on a navigation route according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of embodiments of the present disclosure may be embodied as non-transitory computer readable media on a computer readable medium containing executable program instructions executed by a processor, controller, or the like. Examples of computer readable media include, but are not limited to, ROM, RAM, compact disc (CD)-ROMs, magnetic tapes, floppy disks, flash drives, smart cards, and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to embodiments of the present disclosure, terms such as first, second, A, B, (a), (b), and the like may be used. These terms are merely intended to distinguish the components from other components, and the terms do not limit the nature, order, or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

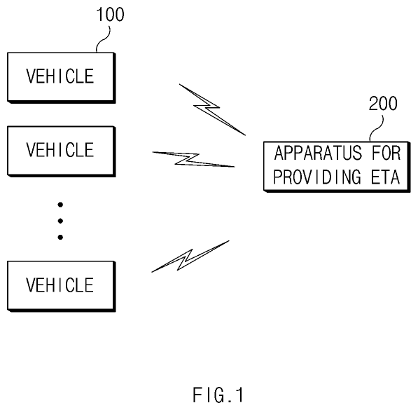

FIG. 1 is an exemplary view of a route guidance system to which an exemplary embodiment of the present disclosure is applied.

As shown in FIG. 1, the route guidance system to which an exemplary embodiment of the present disclosure is applied may include a plurality of vehicles 100 and an apparatus 200 for providing estimated time of arrival (ETA).

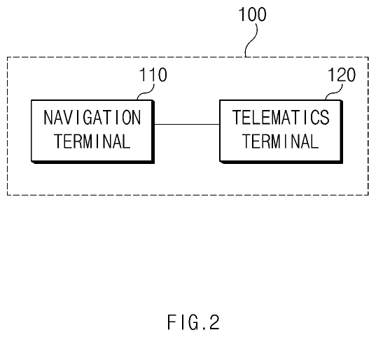

Provided here is a description of each of the above components. First, each vehicle 100 may calculate a vehicle driving speed for each link while driving a navigation route. Here, the driving speed may indicate the speed of a vehicle passing through the link, and the vehicle 100 may calculate the vehicle driving speed by dividing a length of the link by the time required to pass through the link. Each of these vehicles 100 may include a navigation terminal 110 and a telematics terminal 120 as shown in FIG. 2. Here, each vehicle 100 may be a probe vehicle.

FIG. 2 is an exemplary view of a configuration of a vehicle included in the route guidance system to which an exemplary embodiment of the present disclosure is applied.

Referring to FIG. 2, the navigation terminal 110 may generate the navigation route from a departure point to a destination and may calculate the vehicle driving speed for each link included in the navigation route. The navigation terminal 110 may include a power supply device that supplies power to the navigation terminal 110, a global positioning system (GPS) receiver module that receives position coordinates of the vehicle from a GPS satellite, a user input device that receives a user command by a touch or button being pressed, an interface device that connects an external device or an external storage device thereto, an output device that includes a screen display module that displays map information of the navigation and a sound output module that outputs a voice guidance, an altitude measurement device that measures altitude information of a driving vehicle by using a barometer and a controller that generates the navigation route from the departure point to the destination and calculates the vehicle driving speed for each link included in the navigation route. Here, the controller may perform all functions generally provided by the navigation terminal 110.

The telematics terminal 120 may be a module that provides a communication interface with the apparatus 200 for providing ETA and may generally perform a well-known telematics function.

Next, the apparatus 200 for providing ETA, which is a gist of embodiments of the present disclosure, may not only minimize an error between an actual arrival time to a destination and the estimated time of arrival, but also provide a customized estimated time of arrival for each user by collecting the vehicle driving speed for each link included in the navigation route from each vehicle 100, classifying the vehicle driving speed for each link into a plurality of groups (e.g., over-speeding group, average-speeding group and under-speeding group) for each time period, determining a representative speed for each of the plurality of groups, determining a group matching a user past-driving speed for each link, and determining the estimated time of arrival, based on the determined representative speed for each group. The apparatus 200 for providing ETA may be implemented as a server. In addition, the apparatus 200 for providing ETA may be merged with a route guide server (not shown) and may be implemented for the route guide server to perform a function of the apparatus 200 for providing ETA.

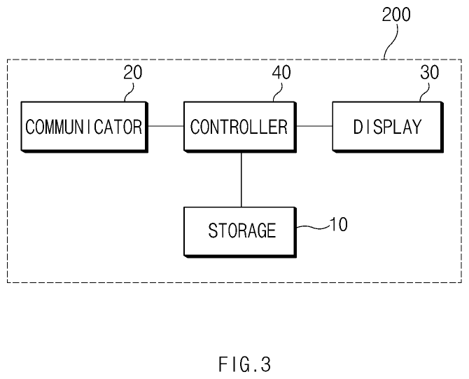

FIG. 3 is a block diagram of an apparatus for providing estimated time of arrival (ETA) on a navigation route according to an exemplary embodiment of the present disclosure.

As shown in FIG. 3, the apparatus 200 for providing estimated time of arrival (ETA) on a navigation route according to an exemplary embodiment of the present disclosure may include a storage 10, a communicator 20, a display 30 and a controller 40. Here, the respective component may be coupled with each other to be implemented as one, or some components may be omitted based on a method of implementing the apparatus 200 for providing estimated time of arrival (ETA) on a navigation route according to an exemplary embodiment of the present disclosure.

Provided here is a description of each of the above components. First, the storage 10 may store various logics, algorithms and programs required for processes of collecting the vehicle driving speed for each link included in the navigation route from each vehicle 100, classifying the vehicle driving speed for each link into the plurality of groups (e.g., over-speeding group, average-speeding group and under-speeding group) for each time period, determining the representative speed for each of the plurality of groups, determining the group matching the user past-driving speed for each link, and determining the estimated time of arrival, based on the determined representative speed for each group.

The storage 10 may store the representative speed corresponding to the speed group for each link for each time period. For example, data stored in the storage 10 may be shown in Table 1 below.

TABLE 1

| | | | Vehicle | Representative |
|---|---|---|---|---|
| Time Period | Link ID | Group ID | Speed | Speed |
| 00:00 to 01:00 | | | | |
| . . . | | | | |
| 13:00 to 14:00 | Link 1 | Group | V1, V2, V3 | J |
| | | “A” | | |
| | | Group | V4, V5, V6 | K |
| | | “B” | | |
| | | Group | V7, V8, V9, V10 | L |
| | | “C” | | |
| | Link 2 | Group | V21, V22, V23 | M |
| | | “A” | | |
| | | Group | V24 | N |
| | | “B” | | |
| | | Group | V25, V26 | Z |
| | | “C” | | |
| | . . . | | | |
| . . . | | | | |
| 23:00 to 24:00 | | | | |

Table 1 is provided to assist in clear understanding of the stored data and shows only some of the entire data. Here, the time period indicates a section that includes time for which the vehicle drives the link and given is an example of the time period divided by one hour. However, the time period may be arbitrarily divided, such as by 10 minutes, 30 minutes, 2 hours, or the like, based on a designer's intention. In addition, given is the example in which the number of groups in each link is divided into three groups including the group “A” (over-speeding group), the group “B” (average-speeding group) and the group “C” (under-speeding group) for example. However, the number of groups may also arbitrarily depend on the designer's intention. In addition, the number of vehicle speeds in each group is only shown partially for clear understanding, an actual number of the vehicle speeds may be much more than this number.

The storage 10 may store a user driving history for each link and a user driving speed for each link. For example, data stored in the storage 10 may be shown in Table 2 below.

TABLE 2

| | | Driving | Driving |
|---|---|---|---|
| User ID | Link ID | History | Speed |
| User 1 | Link 1 | Yes | L |
| | Link 2 | Yes | M |
| | . . . | | |
| User 2 | | | |
| . . . | | | |

Table 2 is provided to assist in clear understanding of the stored data and shows only some of the entire data. Here, there may be a link not including the user driving history.

The storage 10 may store a cosine similarity algorithm as logic for calculating similarity between the links. For reference, the cosine similarity algorithm may indicate a method of obtaining similarity between two vectors by using a cosine angle between the two vectors (i.e., links). The cosine similarity may have a value of 1 when the two vectors have exactly the same direction, a value of zero when the cosine angle between the two vectors is 90°, and a value of −1 when the two vectors have completely opposite directions of 180°, respectively. As a result, the closer the cosine similarity is to 1, the more positive (i.e., higher) the similarity, and the closer the cosine similarity is to −1, the more negative (i.e., lower) the similarity. The cosine similarity (S) may be expressed as in Equation 1 below.

$$S = \frac{\vec{{l}_{a}} \cdot \vec{{l}_{b}}}{\vert \vec{{l}_{a}} \vert \cdot \vert \vec{{l}_{b}} \vert} \qquad [ Equation 1 ]$$

Here, a numerator indicates a dot product of the two vectors, and a denominator indicates a size of each vector.

The storage 10 may include at least one type of a storage medium among types of memories such as a flash memory, a hard disk memory, a micro memory and a card memory (e.g., secure digital (SD) card or extreme digital (XD) card), or types of memories such as a random access memory (RAM), a static RAM (SRAM), a read-only memory (ROM), a programmable ROM (PROM), an electrically erasable PROM (EEPROM), a magnetic memory (or a magnetic RAM (MRAM)), a magnetic disk and an optical disk memory.

The communicator 20 may be a module that provides a communication interface with the telematics terminal 120 included in the vehicle 100 and may receive information on the link the vehicle 100 drives and information on the speed and time in which the vehicle 100 drives the link from the telematics terminal 120.

The communicator 20 may receive a request for information on the ETA on a navigation route from a departure point to a destination from the navigation terminal 110 through the telematics terminal 120 included in the vehicle 100.

The communicator 20 may receive a request to search for the navigation route from a departure point to a destination from the navigation terminal 110 through the telematics terminal 120 included in the vehicle 100.

The communicator 20 may include at least one of a mobile communication module, a wireless internet module or a short-range communication module.

The mobile communication module may communicate with the vehicle 100 through mobile communication network constructed based on a technical standard or a communication method for mobile communication (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE) or long term evolution-advanced (LTE-A).

The wireless internet module may be a module for wireless internet access, and may communicate with the vehicle 100 through wireless local area network (i.e. wireless LAN (WLAN)), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), etc.

The short-range communication module may support short-distance communication with the vehicle 100 by using at least one technology of BLUETOOTH™, radio frequency identification (RFID), infrared data association (IrDA), ultra wideband (UWB), zigbee, near field communication (NFC) and wireless universal serial bus (USB).

The display 30 may be implemented as a cluster, an audio, video, and navigation (AVN) system or the like and may display the information on ETA on a navigation route from a departure point to a destination.

The controller 40 may perform an overall control of each of the above components so that the same component normally performs its function. The controller 40 may be implemented in hardware, or may be implemented in software, or may be implemented in the hardware and the software in combination. The controller 40 may preferably be implemented as a microprocessor and is not limited thereto.

In particular, the controller 40 may perform various controls in the processes of collecting the vehicle driving speed for each link included in the navigation route from each vehicle 100, classifying the vehicle driving speed for each link into the plurality of groups (e.g., over-speeding group, average-speeding group and under-speeding group) for each time period, determining the representative speed for each of the plurality of groups, determining the group matching the user past-driving speed for each link, and determining the estimated time of arrival, based on the determined representative speed for each group.

In determining the group matching the user past-driving speed for each link, the controller 40 may predict the time period in which the user is expected to drive a vehicle for each link and may select a group that includes the user past-driving speed from groups of each link corresponding to the predicted time period. Here, the controller 40 may predict the time period in which the user is expected to drive a vehicle for each link by generally using a well-known technique.

An operation of the controller 40 is hereinafter described in detail.

The controller 40 may collect the vehicle driving speed for each link included in the navigation route from each vehicle 100, classify the vehicle driving speed for each link into the plurality of groups (e.g., over-speeding group, average-speeding group and under-speeding group) for each time period, determine the representative speed for each of the plurality of groups, determine the group matching the user past-driving speed for each link, determine the estimated time of arrival, based on the determined representative speed for each group, and manage a result of determining the group matching the user past-driving speed for each link in a form as shown in Table 1 above.

The controller 40 may collect the vehicle driving speed for each link included in the navigation route from each vehicle 100 through the communicator 20.

The controller 40 may classify the vehicle driving speed for each link into the plurality of groups (e.g., over-speeding group, average-speeding group, and under-speeding group) for each time period. Here, the controller 40 may classify the vehicle driving speed for each link into the plurality of groups by using a clustering algorithm (e.g., K-means), which is a machine learning technique. A result of this classification may be shown in Table 1 above.

The controller 40 may determine the representative speed for each of the plurality of groups. Here, the controller 40 may determine an (arithmetic) average of all speeds in the group as the representative speed, determine an (combined) average of specific speeds in the group as the representative speed, or determine a median value of all speeds in the group as the representative speed. For reference, the median value may indicate a value of the speed positioned in the middle when all the speeds in the group are listed in an ascending order.

The controller 40 may manage the user driving history for each link and the user driving speed for each link. Data managed by the controller 40 may be shown in Table 2 above.

The controller 40 may select a group for each link included in the navigation route from a departure point to a destination, based on the user driving history for each link. For example, the controller 40 may select the group “B” in the link 1 when A1 indicates a speed at which the user drives the link 1, and the A1 is included in the group “B” among the groups of the link 1. In this manner, the controller 40 may select each group in all the links included in the navigation route from a departure point to a destination. Here, in the process of selecting the group for each link included in the navigation route from a departure point to a destination, the controller 40 may predict the time period in which the user is expected to drive each link and select a group that includes the user past-driving speed for each link from groups of each link corresponding to the predicted time period.

The controller 40 may determine the estimated time of arrival, based on the representative speed for each group. That is, the controller 40 may determine the estimated time of arrival, based on the representative speed of each group for all links included in the navigation route from a departure point to a destination. For example, it is assumed that the navigation route from a departure point to a destination includes the link 1, the link 2, and the link 3. In this case, the controller 40 may calculate vehicle driving time in the link 1 by dividing a length of link 1 by the vehicle driving speed in the link 1, may calculate vehicle driving time in the link 2 by dividing a length of link 2 by the vehicle driving speed in the link 2, and may calculate vehicle driving time in a link 3 by dividing a length of link 3 by the vehicle driving speed in the link 3 to calculate a sum of the vehicle driving time in the link 1, the vehicle driving time in the link 2 and the vehicle driving time in the link 3 as the estimated time of arrival on a navigation route.

Meanwhile, the controller 40 may determine the estimated time of arrival on a navigation route from a departure point to a destination even when there is the link not including the user driving history among the links included in the navigation route from a departure point to a destination. That is, the controller 40 may detect a link having a highest similarity to the link not including the user driving history among the links including the user driving history among the links included in the navigation route from a departure point to a destination when there is the link not including the user driving history among the links included in the navigation route from a departure point to a destination, and may determine a group pre-selected in the link having the highest similarity as a group in the link not including the user driving history.

For example, it is assumed that the navigation route from a departure point to a destination includes the link 1, the link 2 and the link 3, and the links 1 and 3 each have the user driving history, and the link 2 does not have the user driving history. In this case, the groups may respectively be normally selected in the links 1 and 3. Here, the controller 40 may determine a link having the highest similarity to the link 2 among the links 1 and 3 by using the cosine similarity algorithm. Here, the controller 40 may determine the group pre-selected in the link 1 as the group in the link 2 when the link 1 has the highest similarity to the link 2. For example, the controller 40 may also select the group “B” in the link 2 when the group selected in the link 1 is the group “B.”

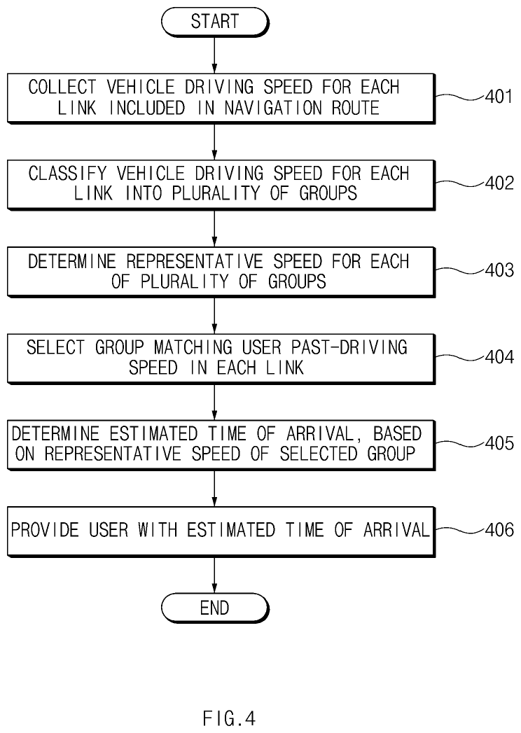

FIG. 4 is a flowchart showing a method of providing ETA on a navigation route according to another embodiment of the present disclosure.

First, the controller 40 may collect a vehicle driving speed for each link included in the navigation route (401).

Next, the controller 40 may classify the vehicle driving speed for each link into a plurality of groups (402).

Next, the controller 40 may determine a representative speed for each of the plurality of groups (403).

Next, the controller 40 may select a group matching a user past-driving speed in each link (404).

Next, the controller 40 may determine the estimated time of arrival, based on the representative speed of the selected group (405).

Next, the display 30 may provide a user with the estimated time of arrival (406).

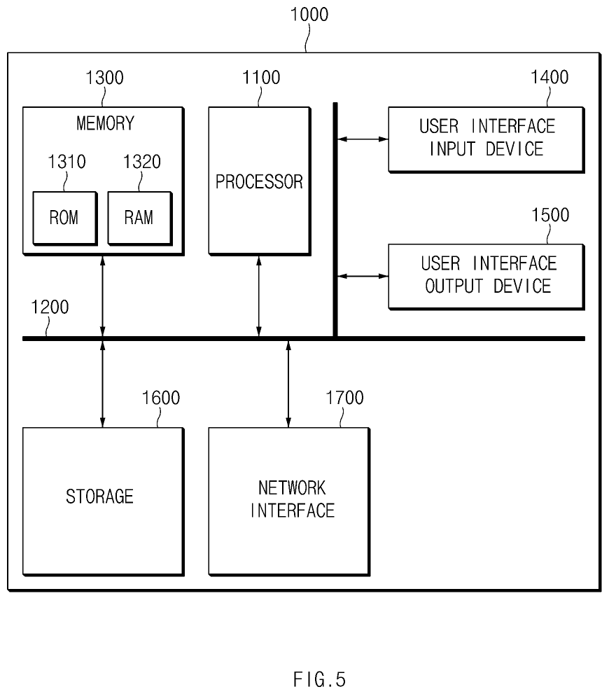

FIG. 5 is a block diagram showing a computing system for executing the method of providing ETA on a navigation route according to another embodiment of the present disclosure.

Referring to FIG. 5, the computing system may also implement the method of providing ETA on a navigation route according to another embodiment of the present disclosure. A computing system 1000 may include at least one processor 1100, a memory 1300, a user interface input device 1400, a user interface output device 1500, a storage 1600 and a network interface 1700, which may be connected to each other by a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an erasable programming ROM (EPROM), an electrically erasable programming ROM (EEPROM), a register, a hard disk, a removable disk, a compact disk-ROM (CD-ROM). The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside in a user terminal. In another case, the processor and the storage medium may reside in the user terminal as separate components.

As set forth above, the apparatus for providing estimated time of arrival on a navigation route and the method thereof according to the embodiments of the present disclosure may not only minimize the error between the actual arrival time to the destination and the estimated time of arrival, but also provide the customized estimated time of arrival for each user, by collecting the vehicle driving speed for each link included in the navigation route, classifying the vehicle driving speed for each link into the plurality of groups (e.g., over-speeding group, average-speeding group and under-speeding group), determining the representative speed for each of the plurality of groups, determining the group matching the user past-driving speed for each link, and determining the estimated time of arrival, based on the determined representative speed for each group.

Hereinabove, although the present disclosure has been described with reference to the embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for providing estimated time of arrival on a navigation route, the apparatus comprising:
a controller configured to:
collect a vehicle driving speed for each link included in the navigation route,
classify the vehicle driving speed for each link into a plurality of groups,
determine a representative speed for each of the plurality of groups,
select a group matching a user past-driving speed for each link, and
determine the estimated time of arrival, based on the representative speed of the selected group; and
a display that provides a user with the estimated time of arrival.

2. The apparatus of claim 1, wherein the controller is further configured to:
predict a time period in which the user is expected to drive a vehicle for each link, and
select a group that comprises the user past-driving speed for each link from groups of each link corresponding to the predicted time period.

3. The apparatus of claim 1, wherein the controller is further configured to:
calculate vehicle driving time for each link by dividing a length of each link by the representative speed for each link, and
determine a sum of the vehicle driving time for each link as the estimated time of arrival.

4. The apparatus of claim 1, wherein the controller is further configured to:
detect a link having a highest similarity to a link not including a user driving history among links including the user driving history when there is the link not including the user driving history among the links included in the navigation route, and
determine a group pre-selected in the link having the highest similarity as a group in the link not including the user driving history.

5. The apparatus of claim 1, wherein the controller is further configured to collect the vehicle driving speed for each link calculated while the vehicle drives each link on the navigation route.

6. The apparatus of claim 5, wherein the vehicle is further configured to calculate the vehicle driving speed in the link by dividing the length of the link by time required to pass through the link.

7. The apparatus of claim 1, wherein the controller is further configured to classify the vehicle driving speed for each link into an over-speeding group, an average-speeding group or an under-speeding group.

8. The apparatus of claim 1, wherein the controller is further configured to determine an average of all speeds in the group as the representative speed.

9. The apparatus of claim 1, wherein the controller is further configured to determine an average of specific speeds in the group as the representative speed.

10. The apparatus of claim 1, wherein the controller is further configured to determine a median value of all speeds in the group as the representative speed.

11. A method of providing estimated time of arrival on a navigation route, the method comprising:
collecting, by a controller, a vehicle driving speed for each link included in the navigation route,
classifying, by the controller, the vehicle driving speed for each link into a plurality of groups,
determining, by the controller, a representative speed for each of the plurality of groups,
selecting, by the controller, a group matching a user past-driving speed for each link,
determining, by the controller, the estimated time of arrival, based on the representative speed of the selected group, and
providing, by a display, a user with the estimated time of arrival.

12. The method of claim 11, wherein the selecting of the group matching the user past-driving speed for each link comprises:
predicting a time period in which the user is expected to drive a vehicle for each link, and
selecting a group that comprises the user past-driving speed for each link from groups of each link corresponding to the predicted time period.

13. The method of claim 11, wherein the determining of the estimated time of arrival comprises:
calculating vehicle driving time for each link by dividing a length of each link by the representative speed for each link, and
determining a sum of the vehicle driving time for each link as the estimated time of arrival.

14. The method of claim 11, wherein the selecting of the group matching the user past-driving speed comprises:
detecting a link having a highest similarity to a link not including a user driving history among links including the user driving history when there is the link not including the user driving history among the links included in the navigation route, and
determining a group pre-selected in the link having the highest similarity as a group in the link not including the user driving history.

15. The method of claim 11, wherein the collecting of the vehicle driving speed for each link comprises:
calculating the vehicle driving speed for each link while the vehicle drives each link on the navigation route, and
collecting the calculated vehicle driving speed for each link.

16. The method of claim 15, wherein the calculating of the vehicle driving speed for each link comprises calculating the vehicle driving speed in the link by dividing the length of the link by time required to pass through the link.

17. The method of claim 11, wherein the classifying of the vehicle driving speed for each link into the plurality of groups comprises classifying the vehicle driving speed for each link into an over-speeding group, an average-speeding group or an under-speeding group.

18. The method of claim 11, wherein the determining of the representative speed for each of the plurality of groups comprises determining an average of all speeds in the group as the representative speed.

19. The method of claim 11, wherein the determining of the representative speed for each of the plurality of groups comprises determining an average of specific speeds in the group as the representative speed.

20. The method of claim 11, wherein the determining of the representative speed for each of the plurality of groups comprises determining a median value of all speeds in the group as the representative speed.
